(19) United States
(12) Patent Application Publication
(10) Pub. No.: US 2010/0223580 A1
(43) Pub. Date: Sep. 2, 2010

(54) DATA BROWSING APPARATUS AND CONTROL METHOD THEREFOR

(75) Inventor: Masato Fujiwara, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/704,203

(22) Filed: Feb. 11, 2010

(30) Foreign Application Priority Data
Feb. 27, 2009 (JP) 2009-047018

(51) Int. Cl. G06F 3/048

(52) U.S. Cl. 715/846

(57) ABSTRACT

First type icon data containing one icon image per content item and second type icon data containing a plurality of icon images per content item are received and temporarily stored in a temporary storage unit. Among the icon data temporarily stored in the temporary storage unit, an icon image is read from each of one or a plurality of icon data items and displayed. In so doing, regarding the second type icon data among the icon data whose icon images are being displayed, a plurality of corresponding icon images are sequentially displayed by being sequentially read out of the temporary storage unit.

### BACKGROUND OF THE INVENTION

1. Field of the Invention

The present invention relates to icon image data read control in displaying icon images corresponding to content.

2. Description of the Related Art

Recently, digital video content, such as images and videos, managed by individuals has been increasing dramatically. Also, digital still cameras and digital video camcorders can shoot both moving images and still images, making it difficult for users to manage and browse video content in their possession by separating between moving images and still images.

Generally, when the user browses only still image content, data is pre-read and cached in advance to display images quickly as the user browses them. Japanese Patent Laid-Open No. 2002-101329 describes a method for reading image data out of a storage medium of a digital still camera and decompressing the image data in advance, and thereby holding preliminary images in a memory of the camera in preparation for display. However, the patent document does not describe browsing in a situation where moving image content and still image content are mixed.

Also, to allow browsing of content containing a mixture of still images and moving images, it is proposed to generate a frame thumbnail from one or more (e.g., four) moving image frames taken out of a moving image and list thumbnails side by side as in the case of still image thumbnails. However, even if thumbnails are displayed, it is difficult to grasp details of the moving image, and it is often the case that the user actually opens and plays the moving image using another application to grasp the details of the moving image. However, a moving image involves a larger amount of data than a still image and takes much time for browsing, making a seamless browsing operation impossible. On the other hand, Japanese Patent Laid-Open No. 2000-23106 describes a method which performs a pre-read prior to a read request from an application when reading a moving image, but performs a normal read when reading a still image. Although this method reduces the time required to display a moving image, the method does not allow the user to browse video content containing a mixture of still images and moving images by switching between the still images and moving images quickly.

### SUMMARY OF THE INVENTION

The present invention has been made in view of the above circumstances. That is, an embodiment of the present invention provides a data browsing apparatus which enables comfortable browsing based on pre-reading even if there is a mixture of moving image content having icon data containing multiple icon images and still image content having icon data containing a single icon image.

According to one aspect of the present invention, there is provided a data browsing apparatus comprising: a temporary storage unit configured to receive and temporarily store first type icon data containing one icon image per content item and second type icon data containing a plurality of icon images per content item; a first reading unit configured to read one icon image per content item from the icon data stored in the temporary storage unit; an icon display unit configured to display the icon images read by the first reading unit; a second reading unit configured to sequentially read, from the temporary storage unit, a plurality of icon images of the second type icon data among the icon data whose icon images are being displayed by the icon display unit and; a sequential display unit configured to display the icon images read by the second reading unit, at a display position of the second type icon data by switching from one icon image to another.

According to another aspect of the present invention, there is provided a data browsing apparatus comprising: a temporary storage unit configured to receive and temporarily store first type icon data containing one icon image per content item, second type icon data containing a plurality of icon images per content item, and attribute data of the icon data; an attribute data reading unit configured to sequentially read the attribute data stored in the temporary storage unit; a first reading unit configured to read, when the attribute data read by the attribute data reading unit indicates the first type, an icon image contained in the icon data corresponding to the attribute data out of the temporary storage unit; an icon display unit configured to display the icon image read by the first reading unit; a second reading unit configured to sequentially read, when the attribute data read by the attribute data reading unit indicates the second type, a plurality of icon images contained in the icon data corresponding to the attribute data out of the temporary storage unit; and a sequential display unit configured to sequentially display the icon images read by the second reading unit.

According to still another aspect of the present invention, there is provided a control method for a data browsing apparatus, comprising: a temporary storage step of receiving and temporarily storing first type icon data containing one icon image per content item and second type icon data containing a plurality of icon images per content item in a temporary storage unit; a first reading step of reading one icon image per content item from the icon data stored in the temporary storage unit; an icon display step of displaying on a screen the icon images read in the first reading step; a second reading step of sequentially reading, from the temporary storage unit, a plurality of icon images of the second type icon data among the icon data whose icon images are being displayed by the icon display step and; a sequential display step of displaying the icon images read in the second reading step, at a display position of the second type icon data by switching from one icon image to another.

According to yet another aspect of the present invention, there is provided a control method for a data browsing apparatus, comprising: a temporary storage step of receiving and temporarily storing first type icon data containing one icon image per content item, second type icon data containing a plurality of icon images per content item, and attribute data of the icon data in a temporary storage unit; an attribute data reading step of sequentially reading the attribute data stored in the temporary storage unit; a first reading step of reading, when the attribute data read in the attribute data reading step indicates the first type, an icon image contained in the icon data corresponding to the attribute data out of the temporary storage unit; an icon display step of displaying on a screen the icon image read in the first reading step; a second reading step of sequentially reading, when the attribute data read in the attribute data reading step indicates the second type, a plurality of icon images contained in the icon data corresponding to the attribute data out of the temporary storage unit; and a sequential display step of sequentially displaying the icon images on the screen read in the second reading step.

Further features of the present invention will become apparent from the following description of exemplary embodiments with reference to the attached drawings.

### BRIEF DESCRIPTION OF THE DRAWINGS

FIG. 1 is a diagram showing a configuration example of a content browsing system according to a first embodiment;

FIG. 2 is a diagram showing an example of a display screen brought up on a display device according to the first embodiment;

FIG. 3 is a block diagram showing a functional configuration example of an image data reading device according to the first embodiment;

FIG. 4 is a diagram showing an example of image data and attribute data stored in a temporary storage unit of an image data reading device according to the first embodiment;

FIG. 5 is a diagram showing how a first reading unit according to the first embodiment reads contents of the temporary storage unit shown in FIG. 4;

FIG. 6 is a diagram showing how a second reading unit according to the first embodiment reads contents of the temporary storage unit shown in FIG. 4;

FIG. 7 is a flowchart showing a process of the image data reading device according to the first embodiment;

FIG. 8 is a diagram showing another example of image data and attribute data stored in the temporary storage unit of the image data reading device according to the first embodiment;

FIG. 9 is a diagram showing an example of the attribute data table shown in FIG. 8;

FIG. 10 is a diagram showing an example of a display screen brought up on a display device according to a second embodiment;

FIG. 11 is a block diagram showing a functional configuration example of an image data reading device according to the second embodiment;

FIG. 12 is a flowchart showing a process of the image data reading device according to the second embodiment; and

FIG. 13 is a flowchart illustrating other processing procedures of the image data reading device according to the first embodiment.

### DESCRIPTION OF THE EMBODIMENTS

Exemplary embodiments of the present invention will be described below with reference to the accompanying drawings.

### First Embodiment

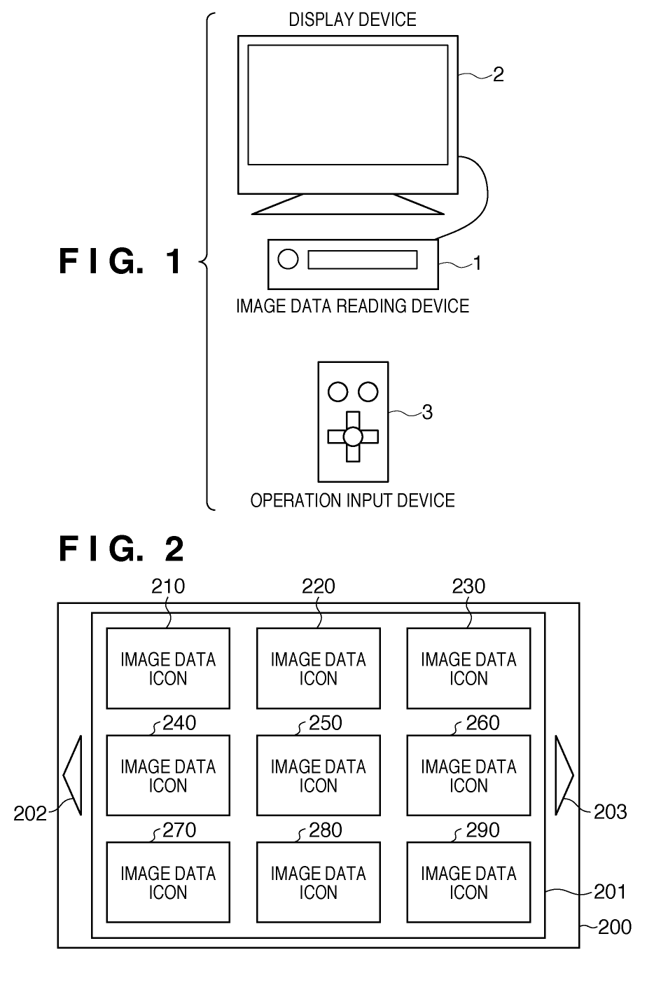

FIG. 1 is a diagram showing a configuration example of a content browsing system according to a first embodiment. In FIG. 1, reference numeral 1 denotes an image data reading device, reference numeral 2 denotes a display device which displays a user interface used to browse video data, and reference numeral 3 denotes an operation input device used for a video data browsing operation.

FIG. 2 is a diagram showing an example of a display screen brought up on a display device 2 of the content browsing system according to the first embodiment.

In FIG. 2, reference numeral 200 denotes the entire display screen of the display device 2 shown in FIG. 1 and reference numerals 210 to 290 denote image data icons used for image display to browse individual items of video data. Reference numeral 201 denotes a page break, and a page on which nine image data icons are grouped is shown here for the sake of convenience. Reference numerals 202 and 203 denote indicators which indicate an operation of changing a displayed page. According to the present embodiment, a display such as shown in FIG. 2 is used to allow the user to browse content.

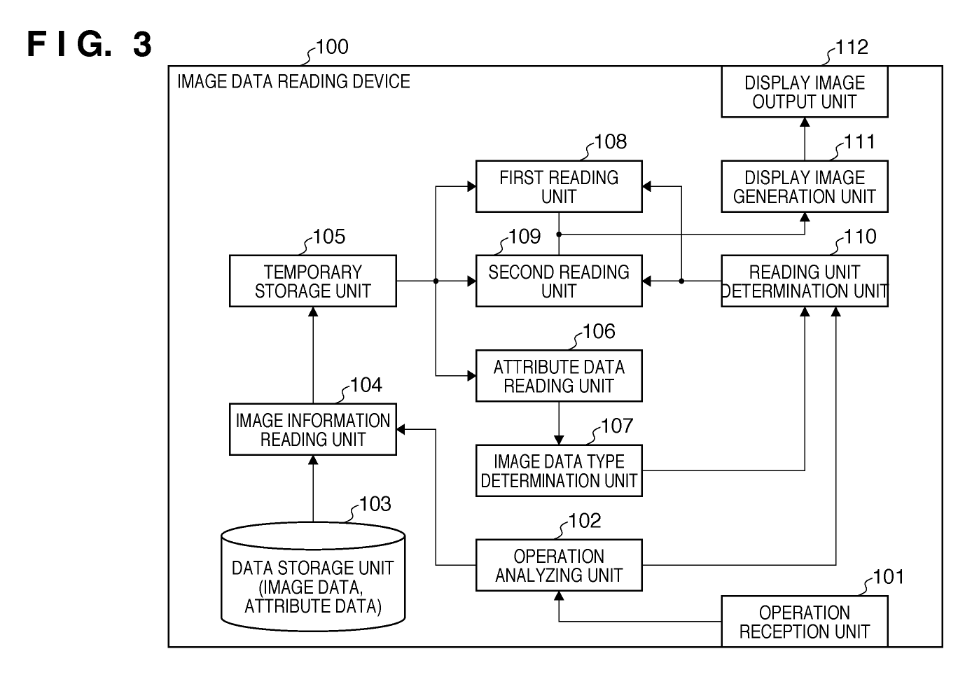

FIG. 3 is a block diagram showing a functional configuration example of an image data reading device 1 according to the first embodiment.

In FIG. 3, reference numeral 100 denotes a main unit of the image data reading device 1 shown in FIG. 1, reference numeral 101 denotes an operation reception unit which receives operations from the operation input device 3 shown in FIG. 1, reference numeral 102 denotes an operation analyzing unit which analyzes operations received by the operation reception unit 101. Reference numeral 103 denotes a data storage unit which stores image data to be displayed on the display device as well as attribute data of the image data. Although illustrated as an internal component for the sake of convenience, the data storage unit 103 may be a storage device provided via communications means (not shown). Reference numeral 104 denotes an image information reading unit which reads image data and attribute data stored in the data storage unit 103. Reference numeral 105 denotes a temporary storage unit which caches the image information and attribute data read out by the image information reading unit 104.

Reference numeral 106 denotes an attribute data reading unit which reads the attribute data cached in the temporary storage unit 105. Reference numeral 107 denotes an image data type determination unit which determines the type of video data indicated by the image data, based on the attribute data read out. The image data type determination unit 107 determines, based on the attribute data, whether the image data of an image data icon represents a moving image frame or a still image.

Reference numeral 108 denotes a first reading unit which reads one item of image data per content item out of the image data cached in the temporary storage unit 105. Details of the operation will be described later. Reference numeral 109 denotes a second reading unit which sequentially reads multiple items of image data for image data icons out of icon data containing the image data items. According to the present embodiment, the second reading unit 109 sequentially reads moving image frames of a same moving image out of the temporary storage unit 105. Reference numeral 110 denotes a reading unit determination unit which determines whether to use the first reading unit 108 or second reading unit 109, for example, based on the type of video data indicated by the attribute data and on an operating condition reported by the operation analyzing unit 102.

Reference numeral 111 denotes a display image generation unit which generates display images to be displayed on the display device 2, using the image data read out of the temporary storage unit 105. Reference numeral 112 denotes a display image output unit which outputs the display images generated by the display image generation unit 111 to the display device 2. Incidentally, although the display image generation unit 111 and display image output unit 112 are illustrated as internal components for the sake of convenience, the image data read out may be transmitted via communications means (not shown) to generate and display the display images in an external display device.

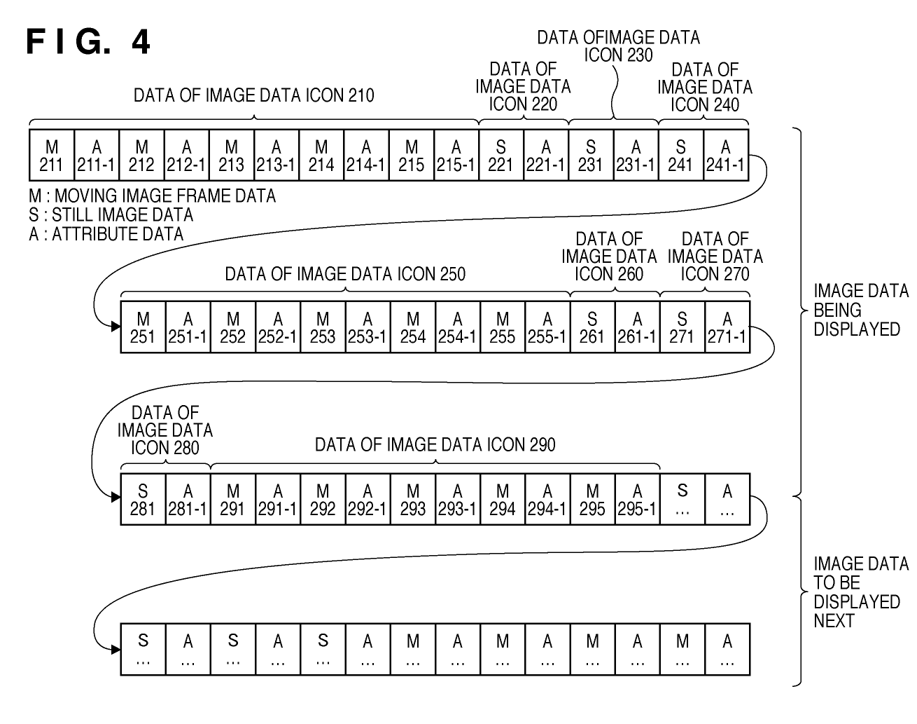

FIG. 4 is a diagram showing an example of image data and attribute data stored in the temporary storage unit 105 of the image data reading device 1 according to the first embodiment.

In FIG. 4, reference numerals 211 to 295 denote image data. The image data in the temporary storage unit 105 contains a mixture of moving image frame data for moving images and still image data for still images. Reference numerals 211-1 to 295-1 denote the attribute data of the image data 211 to 295. The attribute data contains at least information (e.g., a data ID) which uniquely determines the content (video data) indicated by the image data and the type (still image or moving image) of the image data. The moving image frame data stored in the temporary storage unit 105 is data used to display icon images of moving images and obtained, for example, by reducing frame images extracted from the original moving image to the size of an icon.

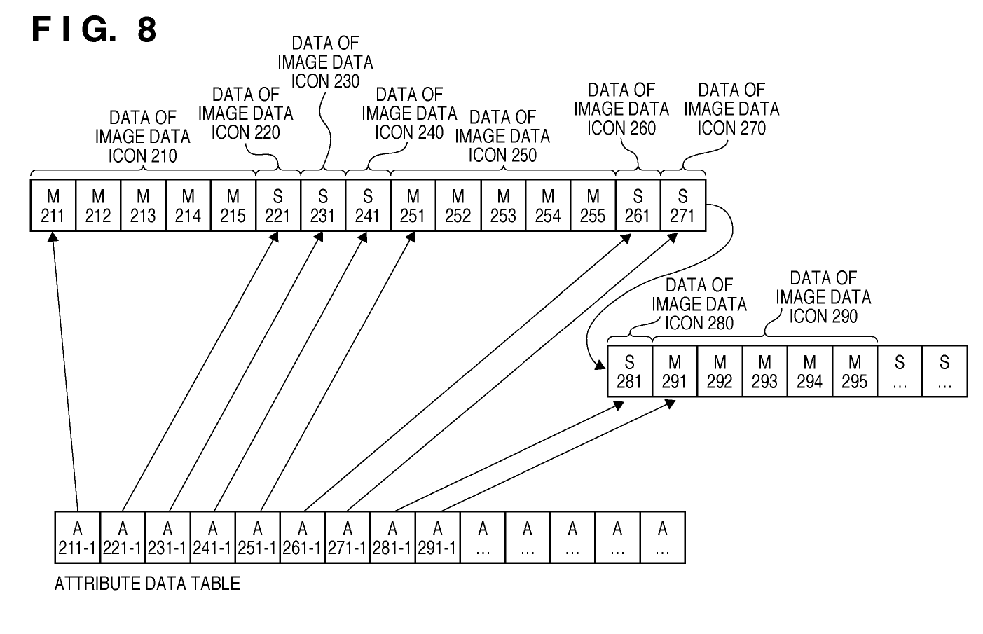

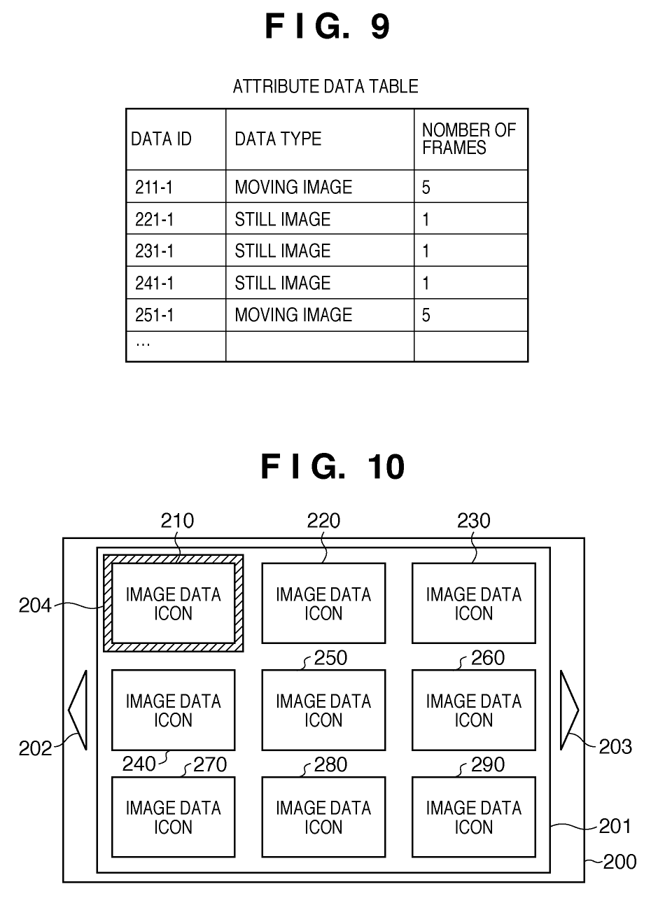

Although in the example shown in FIG. 4, pairs of image data and attribute data are temporarily stored in the cache, this is not restrictive. For example, as shown in FIGS. 8 and 9, image data and an attribute data table may be provided separately and the data type and the number of frames may be registered in the attribute data table to uniquely identity the content corresponding to each image data item and the data type of the image data item.

As described above, icon data of still image content is of a type which contains a single icon image (designated as a first type). On the other hand, icon data of moving image content is of a type which contains multiple icon images per content item (designated as a second type). The data storage unit 103 stores first type icon data and second type icon data (such as described above) as well as attribute data of the icon data. The image information reading unit reads appropriate icon data and corresponding attribute data out of the data storage unit 103 for a data browsing operation of the user and temporarily stores the data in the temporary storage unit 105. The icon data stored in the temporary storage unit 105 is, for example, such icon data that is highly likely to be displayed or is to be displayed in the near future.

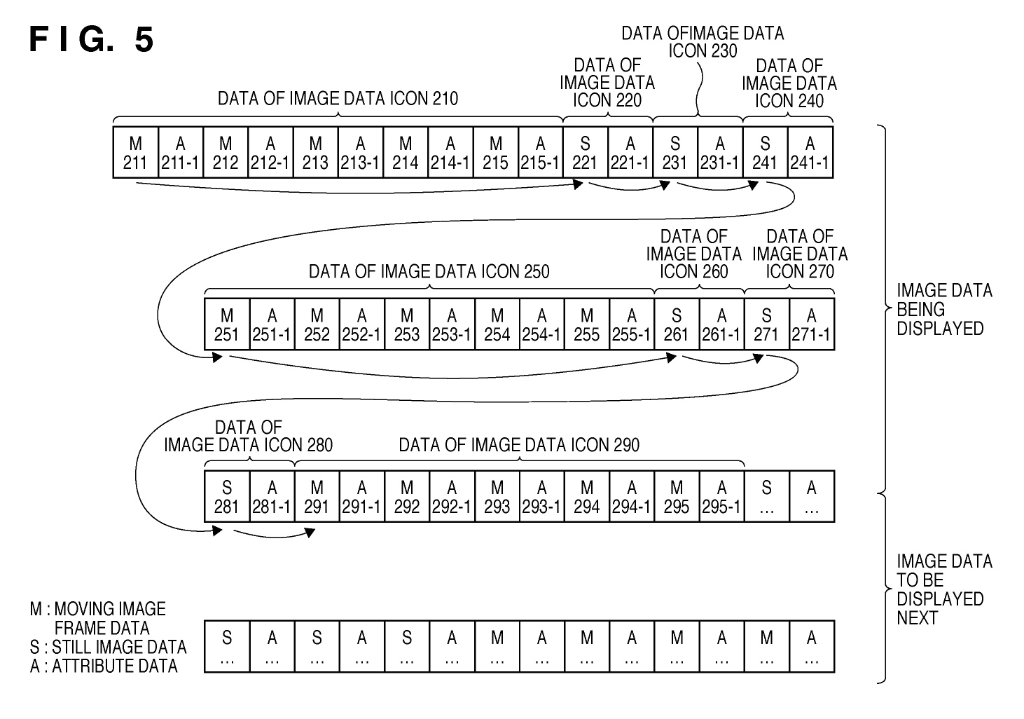

FIG. 5 is a diagram illustrating how the first reading unit 108 according to the first embodiment reads image data out of the temporary storage unit 105. The process of reading image data from the temporary storage unit 105 by the first reading unit 108 will be described taking as an example the case where image data is cached in the temporary storage unit 105 as shown in FIG. 4. As shown in FIG. 5, the first reading unit 108 reads only the first icon image of icon data for different content items (video data) as follows:

moving image frame data 211→still image data 221→still image data 231→ . . . .

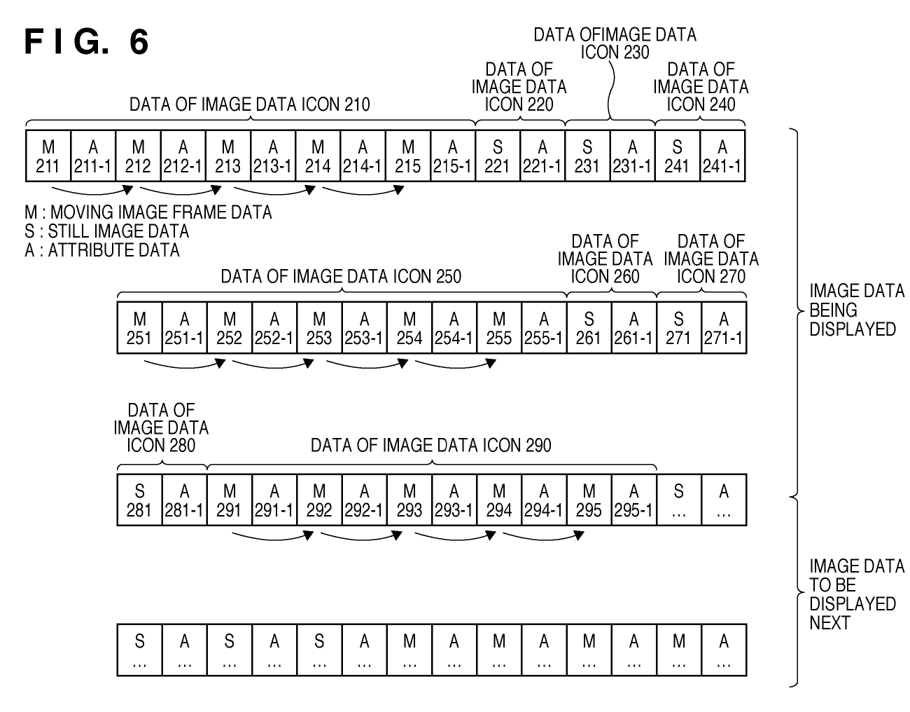

FIG. 6 is a diagram illustrating how the second reading unit 109 according to the first embodiment reads image data out of the temporary storage unit 105. The process of reading image data from the temporary storage unit 105 by the second reading unit 109 will be described taking as an example the case where image data is cached in the temporary storage unit 105 as shown in FIG. 4. The second reading unit 109 sequentially reads multiple icon images of same content (moving image frame data of same moving image data, according to the present embodiment) such as moving image frame data items 211, 212, 213, . . . .

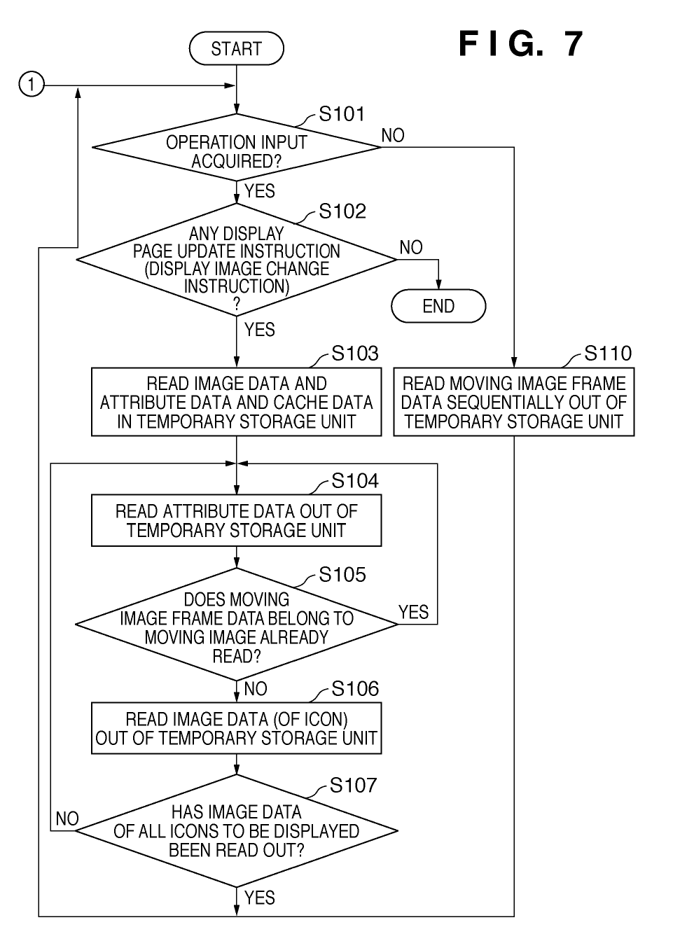

FIG. 7 is a flowchart showing a process example of the image data reading device 1 according to the first embodiment.

First, the operation analyzing unit 102 checks for any operation input in the operation reception unit 101 (step S101). If there is any operation input, the operation analyzing unit 102 determines whether or not the operation input is related to page switching (a display range update instruction) (step S102). If the operation input is related to switching of the displayed page, the image information reading unit 104 reads the image data for icon images and the attribute data of the image data and caches the data in the temporary storage unit 105 (step S103). The caching of icon data in the temporary storage unit 105 is realized by the image information reading unit 104 by reading icon data out of the data storage unit 103 and storing the icon data in the temporary storage unit 105 using known caching techniques including pre-reading of data.

Next, the attribute data reading unit 106 first reads the attribute data 211-1 cached in the temporary storage unit 105 (step S104). Then, the image data type determination unit 107 determines whether the read attribute data is the attribute data of moving image frame data of a moving image already read (step S105). In this case, the attribute data 211-1 is related to the moving image frame data of a moving image read for the first time. Therefore, the reading unit determination unit 110 instructs the first reading unit 108 to read the moving image frame data 211 corresponding to the attribute data 211-1 (step S106). The display image generation unit 111 generates a display image for icon display so as to display an icon image from the moving image frame data 211 at display position of the image data icon 210.

The attribute data reading unit 106 determines whether the attribute data of all the image data to be displayed on the screen has been read out (step S107). If the attribute data has not been read out, the processing returns to S104. After the attribute data 211-1 is read out, the attribute data reading unit 106 reads the attribute data 212-1 out of the temporary storage unit 105 as described above (step S104). Then, the image data type determination unit 107 determines whether the moving image frame data belongs to the moving image already read (step S105). In the present example, since the moving image frame data 212 belongs to the same moving image as the moving image frame data 211, the processing returns to step S104. Steps S104 and S105 are repeated, and when the attribute data 221-1 of the still image data 221 is read out, the still image data 221 is read out in step S106. Then, the display image generation unit 111 generates a display image to display an icon image of the still image data 221 at display position of the image data icon 220 in the manner shown in FIG. 2.

Although in the example described above, all the attribute data is read sequentially, if a pointer to the attribute data of the next video image data item is included in each attribute data item, useless reading and determination regarding attribute data can be omitted. For example, in the data structure illustrated in FIGS. 8 and 9, if icon data and attribute data are cached in the temporary storage unit 105, since the attribute data items read sequentially indicate different content items, the determination in step S105 can be omitted.

When image data for all the image data icons has been read out, the processing returns from step S107 to step S101. Subsequently, if there is no new operation input, the reading unit determination unit 110 determines to use the second reading unit 109. The second reading unit 109 sequentially reads moving image frame data of the same moving image (step S110), the moving image frame data having been cached in the temporary storage unit 105. For example, the moving image frame data items 211 to 215 are read sequentially. The display image generation unit 111 generates display images and overwrites the image data icons of the newly read moving image frame data on the displayed image data icon of the moving image frame data of the same moving image, and thereby sequentially displays icon images. For example, icon images of the moving image frame data 211 to 215 are sequentially displayed at the display position of the image data icon 210.

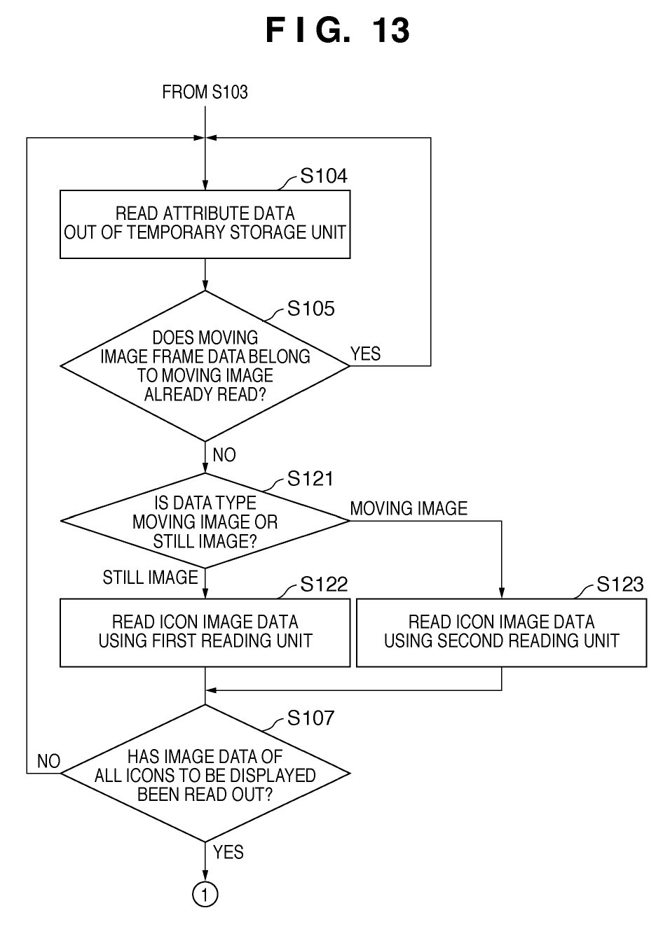

In the process flow described above, the image data of all the content (video data) is read item by item before the moving image frame data of the moving image is read sequentially. However, the reading unit determination unit 110 may dynamically switch to the second reading unit 109 in the case of moving image frame data so that the moving image frame data will be read sequentially, and then dynamically switch again to the first reading unit 108 after the moving image frame data has been read out. This process will be described with reference to a flowchart in FIG. 13.

If it is determined in step S105 described above that the moving image frame data does not belong to the moving image already read, the processing goes to step S121. In step S121, the image data type determination unit 107 determines whether the content is a moving image or still image based on the attribute data read out and notifies the reading unit determination unit 110. If a notification about a still image is received, the reading unit determination unit 110 instructs the first reading unit 108 to read the appropriate icon image data. Consequently, the first reading unit 108 reads one item of icon image data from the icon data corresponding to the attribute data and displays the icon image on the screen (step S122). On the other hand, if a notification about a moving image is received, the reading unit determination unit 110 instructs the second reading unit 109 to read the appropriate icon image data. Consequently, the second reading unit 109 sequentially reads multiple items of icon image data from the icon data corresponding to the attribute data and sequentially displays the icon images at appropriate positions on the screen (step S123). Incidentally, the reading by the first reading unit 108 and reading by the second reading unit 109 proceed concurrently in appearance. Subsequently, in step S110, out of one or more items of icon data being displayed, multiple icon image data items of the moving image are read sequentially and displayed sequentially at icon display positions of the moving image.

Incidentally, the image data may be reduced images of video data, i.e., thumbnail image data. This means that the still image data may be still image thumbnails and that the moving image frame data may be moving image frame thumbnails.

Also, if multiple items of moving image frame thumbnail image data are archived together, thereby generating moving image thumbnail data, the moving image thumbnail data can be treated as a unit for reading image data.

If moving image frame data corresponds to all the frames in an arbitrary part of the moving image, preferably the second reading unit 109 reads the moving image frame data at a rate equivalent to the frame rate of the moving image. Also, moving image frame data may be set such as to correspond to frames obtained by removing some frames uniformly from all the frames in an arbitrary part of the moving image. In that case, preferably the second reading unit 109 reads the moving image frame data from the temporary storage unit 105 at a frame rate established by taking the removal of some frames into consideration. If only an arbitrary part of moving image frame data of a moving image is cached in the temporary storage unit 105, moving image frame data or the moving image itself is read out while display images are generated by sequentially reading the cached preceding moving image frame data from the cache. This will enable seamless browsing of the moving image without compromising immediacy of the browsing.

### Second Embodiment

Next, a second embodiment will be described. Incidentally, description of parts corresponding to those of the first embodiment will be omitted.

FIG. 10 is a diagram showing an example of a display screen brought up on the display device 2 of a content browsing system according to the second embodiment. The second embodiment in FIG. 10 differs from the first embodiment in FIG. 2 in that an image data icon can be selected through user's operation input and that the selected image data icon can be displayed in focus 204.

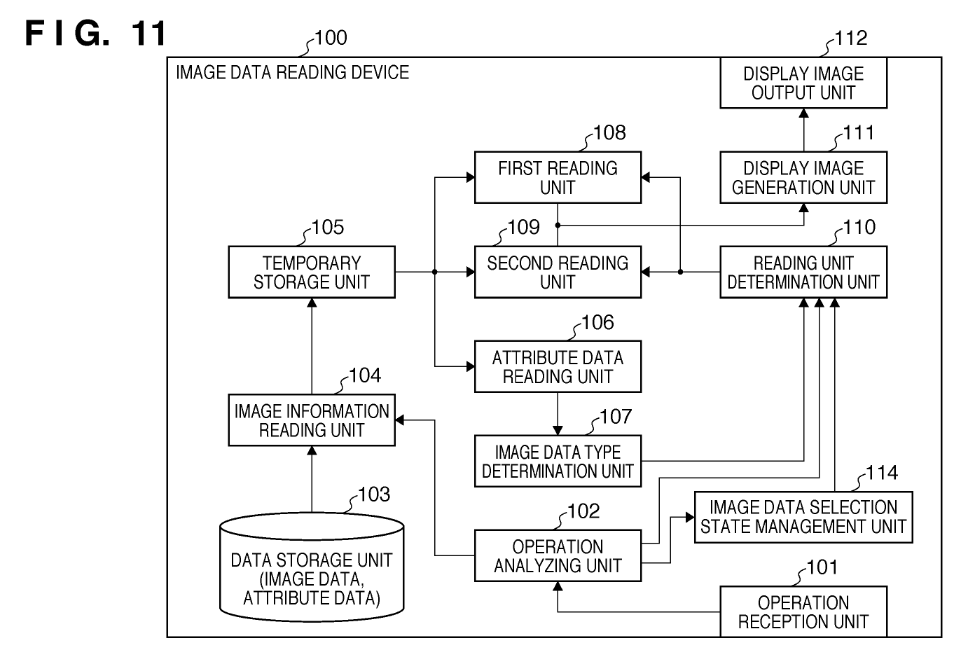

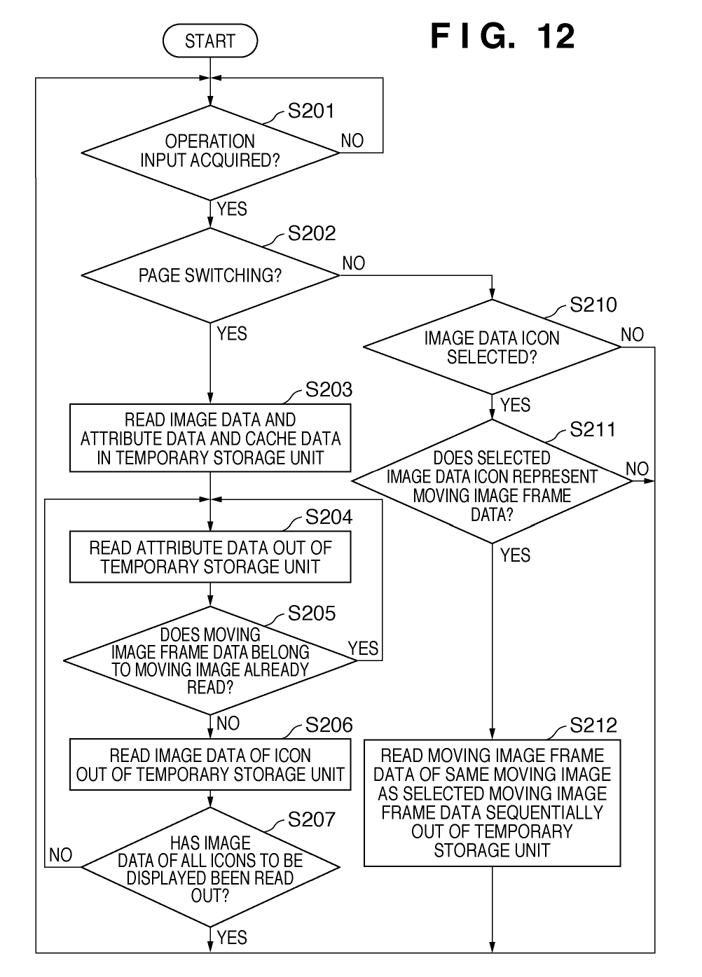

FIG. 11 is a diagram showing a configuration example of the image data reading device 1 according to the second embodiment.

The present embodiment in FIG. 11 differs from the first embodiment in FIG. 2 in that an image data selection state management unit 114 is provided to manage selection state of image data resulting from user's operation input. According to the second embodiment, determination is made based also on the selection state of image data.

The selection state of image data is reported to the reading unit determination unit 110 by the image data selection state management unit 114. Available selection states include a non-selected state in which no image data icon is selected and a selected state in which an image data icon is selected. In the non-selected state, the reading unit determination unit 110 finishes processing without changing the reading unit from the first reading unit 108. In the selected state, if the image data represented by the selected image data icon is moving image frame data, the reading unit determination unit 110 determines to use the second reading unit 109.

Next, a process of the image data reading device 1 according to the second embodiment will be described with reference to a flowchart in FIG. 12.

First, the operation analyzing unit 102 checks whether there is any operation input via the operation reception unit 101 (step S201). If there is no operation input, the operation analyzing unit 102 waits until there is an operation input. When an operation input is acquired, the operation analyzing unit 102 determines whether the operation is related to page switching (instruction to update the display range of the screen) (step S202). If the operation is related to page switching, the image information reading unit 104 acquires an item of image data from each item of icon data and thereby displays image icons (steps S203 to S207), as in the case of steps S103 to S107 according to the first embodiment.

If it is determined in step S202 that the operation is not related to page switching, the operation analyzing unit 102 checks whether the operation is related to selection of an image data icon (step S210). If the operation is not related to selection of an image data icon, the processing returns to step S201.

On the other hand, if the operation is related to selection of an image data icon, the attribute data reading unit 106 reads the attribute data of the image data icon selected by the operation. Then, the image data type determination unit 107 determines whether or not the selected image data icon (i.e., focused image data icon) represents moving image frame data (step S211). If the selected image data icon does not represent moving image frame data of a moving image, the processing returns to step S201. On the other hand, if the selected image data icon represents moving image frame data of a moving image, the reading unit determination unit 110 determines to use the second reading unit 109. The second reading unit 109 sequentially reads the moving image frame data of the same moving image in the manner described in step S110 of the first embodiment (step S212). Using the moving image frame data read out, the display image generation unit 111 generates display images so as to display image data of the selected image data icon by switching from one image data item to another.

Incidentally, steps S204 to S207 may be replaced by steps in FIG. 13 as in the case of the first embodiment.

In the embodiments described above, multiple moving image frame thumbnails of a moving image and still image thumbnails are cached in a similar manner, and cache read control is automatically switched among focus shifting, still image display, and moving image display. This enables comfortable browsing of video content, including grasping the details of the moving image, without bothering the user and improves interactivity during browsing by means of caching.

Incidentally, although in the description of the embodiments, moving image video data and still image video data have been cited as examples of the content represented by icons for the sake of convenience, this is not restrictive. For example, the present invention can handle multi-page and single-page document data as well.

Incidentally, although in the above embodiments, the format shown in FIG. 2 or 10 has been described as an example of an icon image display format, this is not restrictive. For example, icon images may be displayed in a list format or scrollable column format. Also, an icon image for a single content item may be displayed.

The present invention enables comfortable browsing based on pre-reading even if there is a mixture of moving image content having icon data containing multiple icon images and still image content having icon data containing a single icon image.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-047018, filed Feb. 27, 2009, which is hereby incorporated by reference herein in its entirety.

What is claimed is:

1. A data browsing apparatus comprising:
a temporary storage unit configured to receive and temporarily store first type icon data containing one icon image per content item and second type icon data containing a plurality of icon images per content item;
a first reading unit configured to read one icon image per content item from the icon data stored in said temporary storage unit;
an icon display unit configured to display the icon images read by said first reading unit;
a second reading unit configured to sequentially read, from said temporary storage unit, a plurality of icon images of the second type icon data among the icon data whose icon images are being displayed by said icon display unit and;
a sequential display unit configured to display the icon images read by said second reading unit, at a display position of the second type icon data by switching from one icon image to another.

2. The data browsing apparatus according to claim 1, wherein from when said icon display unit completes the display until a new display range update instruction is input, said second reading unit and the sequential display unit repeat processing the second type icon data temporarily stored in said temporary storage unit.

3. The data browsing apparatus according to claim 1, wherein if a focused icon image among the displayed icon images is from the second type icon data, said second reading unit and said sequential display unit process the focused icon data.

4. A data browsing apparatus comprising:
a temporary storage unit configured to receive and temporarily store first type icon data containing one icon image per content item, second type icon data containing a plurality of icon images per content item, and attribute data of the icon data;
an attribute data reading unit configured to sequentially read the attribute data stored in said temporary storage unit;
a first reading unit configured to read, when the attribute data read by said attribute data reading unit indicates the first type, an icon image contained in the icon data corresponding to the attribute data out of said temporary storage unit;
an icon display unit configured to display the icon image read by said first reading unit;
a second reading unit configured to sequentially read, when the attribute data read by said attribute data reading unit indicates the second type, a plurality of icon images contained in the icon data corresponding to the attribute data out of said temporary storage unit; and
a sequential display unit configured to sequentially display the icon images read by said second reading unit.

5. The data browsing apparatus according to claim 4, wherein from when said display unit finishes displaying the one or plurality of icon data items to be displayed until a new display range update instruction is input, said second reading unit and said sequential display unit repeat processing the second type icon data among the one or plurality of icon data items to be displayed.

6. The data browsing apparatus according to claim 4, wherein if a focused icon image among the displayed icon images is the second type icon data, said second reading unit and said sequential display unit sequentially display a plurality of icon images from the focused icon data.

7. The data browsing apparatus according to claim 1, wherein content corresponding to the first type icon data is still image data and content corresponding to the second type icon data is moving image data.

8. The data browsing apparatus according to claim 1, wherein content corresponding to the first type icon data is single-page document data and content corresponding to the second type icon data is multi-page document data.

9. The data browsing apparatus according to claim 1, wherein said second reading unit and said sequential display unit read and display the plurality of icon images at a frame rate of moving image data.

10. A control method for a data browsing apparatus, comprising:
a temporary storage step of receiving and temporarily storing first type icon data containing one icon image per content item and second type icon data containing a plurality of icon images per content item in a temporary storage unit;
a first reading step of reading one icon image per content item from the icon data stored in the temporary storage unit;
an icon display step of displaying on a screen the icon images read in said first reading step;
a second reading step of sequentially reading, from the temporary storage unit, a plurality of icon images of the second type icon data among the icon data whose icon images are being displayed by said icon display step and;
a sequential display step of displaying the icon images read in said second reading step, at a display position of the second type icon data by switching from one icon image to another.

11. A control method for a data browsing apparatus, comprising:
a temporary storage step of receiving and temporarily storing first type icon data containing one icon image per content item, second type icon data containing a plurality of icon images per content item, and attribute data of the icon data in a temporary storage unit;
an attribute data reading step of sequentially reading the attribute data stored in the temporary storage unit;
a first reading step of reading, when the attribute data read in said attribute data reading step indicates the first type, an icon image contained in the icon data corresponding to the attribute data out of the temporary storage unit;
an icon display step of displaying on a screen the icon image read in said first reading step;
a second reading step of sequentially reading, when the attribute data read in said attribute data reading step indicates the second type, a plurality of icon images contained in the icon data corresponding to the attribute data out of the temporary storage unit; and
a sequential display step of sequentially displaying the icon images on the screen read in said second reading step.

12. A computer-readable storage medium storing a computer program which makes a computer execute the steps of the control method for a data browsing apparatus according to claim 10.

13. A computer-readable storage medium storing a computer program which makes a computer execute the steps of the control method for a data browsing apparatus according to claim 11.
